(19) United States
(12) Patent Application Publication
(10) Pub. No.: US 2007/0090319 A1
(43) Pub. Date: Apr. 26, 2007

(54) Valves for drinking vessels

(75) Inventor: Jon Grant, Surrey (GB)

Correspondence Address: BLANK ROME LLP, 600 NEW HAMPSHIRE AVENUE, N.W., WASHINGTON, DC, 20037, US

(73) Assignee: BW TECHNOLOGIES LTD., Farnham, Surrey (GB)

(21) Appl. No.: 10/565,528

(22) PCT Filed: Jul. 26, 2004
(86) PCT No.: PCT/GB04/03213

§ 371 Date: Jun. 30, 2006

(30) Foreign Application Priority Data
Jul. 24, 2003 (GB) 0317291.3

(51) Int. Cl. F16L 37/28

(52) U.S. Cl. 251/149.6

(57) ABSTRACT

A valve for selectively providing access to a supply of drinking fluid retained within a portable flexible container (18) comprises a tubular body (1) having at one end a stem (2) insertable into an opening in communication with the container and at its other end an outlet (3) through which fluid from the container can leave the valve. A piston (6) is mounted for sliding movement within a central bore (4) of the body and is resiliently urged into engagement with an annular seating (11) positioned at the bore end closest to the outlet (3). Means are provided for moving the piston (6) against the action of the resilient means (14) to enable fluid to be drawn from the container past the piston and through the outlet.

This invention relates valves for drinking vessels and more especially to valves for selectively providing access to a supply of drinking fluid retained within a portable flexible container from which fluid can be sucked via a drinking tube.

Flexible portable containers for drinkable fluids such as water are conventionally carried on a person's back or chest when travelling through the countryside and less environmentally friendly terrains. ON/OFF valves are employed for many such containers to prevent loss of drinking fluid through spillage and to provide ready access to the fluid when required. There are occasions when there is a need for personnel to wear face masks for protection against, for example, the presence of poisonous substances In the atmosphere. On such occasions it is important that the mask wearer can still gain ready access to drinking fluid without removing the protective mask.

Many valved containers for drinking fluids are of solid construction. These can only be used by inverting or inclining the container and the user blowing into the container outlet to open the valve to enable water to leave the container. Such containers are extremely cumbersome to use particularly if the user is wearing a face mask.

According to the present invention in one aspect, there is provided a valve for selectively providing access to a supply of drinking fluid retained within a portable flexible container, the valve comprising a tubular body having at one end a stem insertable into an opening in communication with the container and at its other end an outlet through which fluid from the container can leave the valve, a piston mounted for sliding movement within a central bore of the body and resilient means for urging the piston into engagement with an annular seating positioned at the bore end closest to the outlet, and means for moving the piston against the action of the resilient means to enable fluid to be drawn from the container past the piston and through the outlet.

The stem may be formed with two or more annular serrations or steps to assist retention within the opening in communication with the container. The container may be connected to the valve through a flexible conduit one end of which defines the opening in communication with the container. In this arrangement, the stepped stem is inserted into that end of the conduit remote from the container. An ON/OFF valve may be positioned within or adjoining one end of the conduit selectively to control the flow of drinking fluid from the container to the valve.

The resilient means may comprise a coil spring positioned between an annular retainer located within the central bore of the body and the opposed end of the piston.

The annular seating may be tapered inwardly towards the outlet of the valve with the piston end closest to the outlet being similarly tapered to provide an effective seal as the piston is urged by the spring Into contact with the seating.

The piston may Include one or more internal open-ended passageways through which water drawn into the valve can pass to the outlet when the piston is moved away from its seating.

The outlet may be formed in a tubular end piece of the body. In a preferred arrangement, the end of the piston remote from the stem is positioned below the outlet. In this arrangement, the piston is movable from its position in sealing engagement with the annular seating by a male member carried by a conduit through which drinking fluid can be drawn from the container. The male member may comprise a tubular casing in which is mounted a central rod spaced from the internal wall of the casing by an annular seal displaceable through contact with the piston end.

The invention will now be described, by way of example only, with reference to the accompanying diagrammatic drawings in which

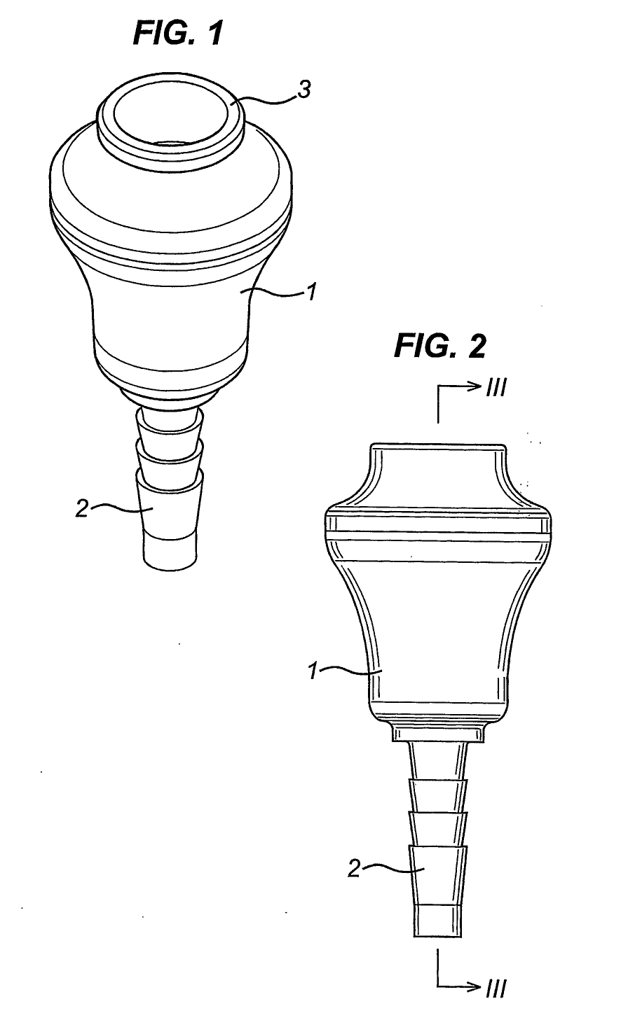

FIG. 1 is a perspective view of a valve in accordance with the invention;

FIG. 2 Is a side view of the valve shown in FIG. 1;

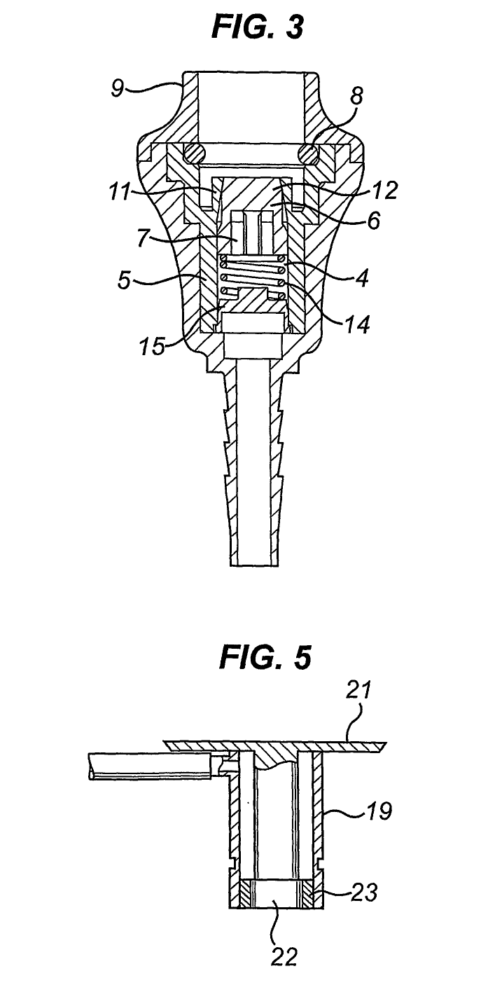

FIG. 3 is a sectional view taken along line III-III of FIG. 2;

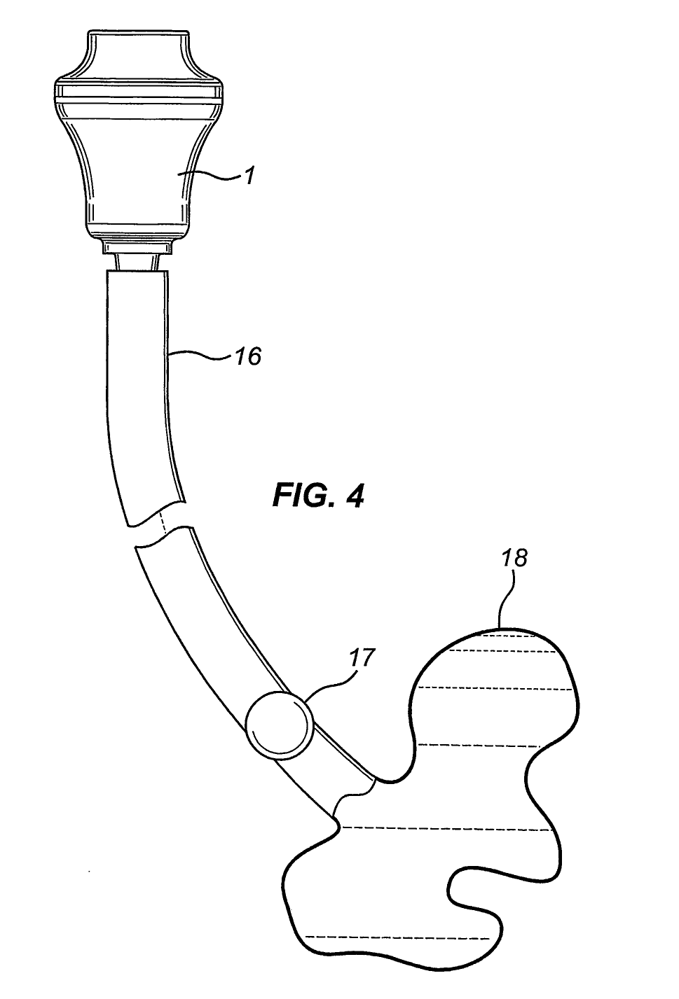

FIG. 4 illustrates In section the valve shown in FIGS. 1 to 3 when attached through a conduit to a drinking vessel; and

FIG. 5 illustrates in section a connection for the valve to a conduit of a face mask.

The valve Illustrated in FIGS. 1 to 3 comprises a hollow body 1 having at one end a hollow stem 2 and at its other end an outlet 3. The external surface of the stem 2 is serrated to enable it to be readily inserted into one end of a flexible tube (see FIG. 4) of a portable fluid container. The body 1 has a central bore 4 in which is positioned a hollow insert 5 which houses a piston 6. The piston is formed with internal open-ended channels 7 which extend upwardly away from the under surface of the piston and then outwardly to one or more piston side edges. An “O” ring 8 is positioned within an annular recess formed in the end of the insert closest to the outlet 3. As will be seen from FIG. 1, the outlet is defined by a tubular end piece 9 of the body. The insert includes an annular tapered seating 11 whose surface matches a tapered end 12 of the piston 6. The piston is urged towards the outlet 3 by a coil spring 14 whose end remote from the piston is positioned on an annular retainer 15.

With the piston 6 moved downwardly against the action of the spring, a continuous passageway for the flow of drinking fluid is provided through the valve.

As will be seen from FIG. 4 of the drawings, the serrated stem 2 is forcibly inserted into one end of a flexible tube 16 connected at its other end via an ON/OFF valve 17 to a flexible container 18 containing water. Movement of the valve 17 to its “OFF” position prevents the flow of water from the container. Movement of the valve 17 to its “open” position enables water to be sucked by mouth from the container.

FIG. 5 illustrates a connector between the tubular end piece 9 of the valve and a tube 20 through which water can be sucked by the user.

The connector comprises a tubular housing 19 open at one end and closed at its other end by a plate 21. A rod 22 of circular section protrudes from the surface of the plate and is spaced from the internal wall of the housing 19 by flexible annular lining 23 which, when the connector is inserted into the end piece 9, is moved in a direction towards the plate 21 to provide communication between the outlet 3 and the annular space defined between the internal surface of the housing 19 and the external surface of the rod 22. At the same time, the rod engages the opposed end of the piston to move the piston 6 from its seating to enable water to flow into and through the connector to the tube. The outer surface of the housing 19 Is formed with an annular recess to receive the “O” ring 8 when the connector is inserted into the end piece 9 of the valve.

In the position shown in FIG. 3, the piston sealingly engages the tapered seating 11 to prevent communication between the bores of the stem 2 and the outlet 3. Downward pressure on the piston end by the rod 22 of the connector moves the piston downwardly away from its seating to enable drinking fluid from the container to pass via the stem through the central bore of the valve and into the outlet. Movement of the lining 23 enables drinking fluid to flow through the connector and into the tube 20.

In use, the end of the tube 20 remote from the connector may be connected to a drinking tube positioned within a face mask. This enables the wearer to access the drinking fluid even when wearing a face mask simply by operating the ON/OFF valve 17.

It will be appreciated that the foregoing is merely exemplary of valves in accordance with the invention and that modifications can readily be made thereto without departing from the true scope of the invention.

1. A valve for selectively providing access to a supply of drinking fluid retained within a portable flexible container, the valve comprising a tubular body having at one end a stem insertable into an opening in communication with the container and at its other end an outlet through which fluid from the container can leave the valve, a piston mounted for sliding movement within a central bore of the body and resilient means for urging the piston into engagement with an annular seating positioned at the bore end closest to the outlet, and means for moving the piston against the action of the resilient means to enable fluid to be drawn from the container past the piston and through the outlet.

2. A valve as claimed in claim I wherein the stem is formed with two or more annular serrations or steps to assist retention within the opening in communication with the container.

3. A valve as claimed in claim 1 wherein the container is connected to the valve through a flexible conduit one end of which defines the opening in communication with the container.

4. A valve as claimed in claim 3 wherein the stepped stem is inserted into that end of the conduit remote from the container.

5. A valve as claimed in claim 1 wherein the ON/OFF valve is positioned within or adjoining one end of the conduit selectively to control the flow of drinking fluid from the container to the valve.

6. A valve as claimed in claim 1 wherein the resilient means comprises a coil spring positioned between an annular retainer located within the central bore of the body and the opposed end of the piston.

7. A valve as claimed in claim 1 wherein he annular seating is tapered inwardly towards the outlet of the valve with the piston end closest to the outlet being similarly tapered to provide an effective seal as the piston is urged by the spring into contact with the seating.

8. A valve as claimed in claim 1 wherein the piston includes one or more internal open-ended passageways through which water drawn into the valve can pass to the outlet when the piston is moved away from its seating.

9. A valve as claimed in claim 1 wherein the outlet is formed in a tubular end piece of the body.

10. A valve as claimed in claim 1 wherein the end of the piston remote from the stem is positioned below the outlet.

11. A valve as claimed in claim 10 wherein the piston is movable from its position in sealing engagement with the annular seating by a male member carried by a conduit through which drinking fluid can be drawn from the container.

12. A valve as claimed in claim 11 wherein the male member comprises a tubular casing in which is mounted a central rod spaced from the internal wall of the casing by an annular seal displaceable through contact with the piston end.

13. A valve substantially as herein described and as described with reference to the accompanying diagrammatic drawings.
